(19) United States
(12) Patent Application Publication
(10) Pub. No.: US 2025/0375864 A1
(43) Pub. Date: Dec. 11, 2025

(54) DRIVER BLADE GUIDE FOR A FASTENING TOOL

(71) Applicant: Black & Decker, Inc., New Britain, CT (US)

(72) Inventors: Daryl S. MEREDITH, York, PA (US); Jared W. Rondeau, Dayville, CT (US); Michael Justis, Towson, MD (US)

(21) Appl. No.: 19/244,690

(22) Filed: Jun. 20, 2025

Related U.S. Application Data
(63) Continuation of application No. PCT/US2024/010055, filed on Jan. 2, 2024.
(60) Provisional application No. 63/436,464, filed on Dec. 30, 2022.

(51) Int. Cl. B25C 1/00; B25C 1/06

(52) U.S. Cl. CPC B25C 1/008; B25C 1/06

(57) ABSTRACT

A fastening tool having a stationary member that can guide the tip of a driver blade along a drive track and can prevent the driver blade from becoming dislodged from the drive track when driver member is in the home position.

### CROSS-REFERENCE TO RELATED APPLICATIONS

The present application is a continuation of international application PCT/US2024/010055 filed on Jan. 2, 2024 which claims priority to U.S. Provisional Patent Application Ser. No. 63/436,464, entitled “Driver Blade Guide for a Fastening Tool”, filed Dec. 30, 2022. The entirety of the above application is incorporated herein by reference.

### BACKGROUND OF THE INVENTION

### Field of the Invention

The present invention relates, in general, to the field of power tools. In particular, the present invention relates to a fastening or driving tool, such as a nailer and more particularly to improvements in reducing the size and weight of the tool. In particular, the present invention relates to a fastening tool having a driver blade guide.

### Description of the Related Art

Different types of fastening tools are known including portable pneumatically actuated devices, electrically actuated devices, hammer actuated devices, manual actuated devices, etc. Fastening tools, such as power nailers and staplers have become relatively common place in the construction industry. Battery-powered nailers are popular in the market.

A common characteristic of all these types of fastening tools is the provision of a drive track, a fastener driving element mounted in the drive track and a magazine assembly for receiving a supply of fasteners in stick formation and feeding successive leading fasteners in the stick laterally into the drive track to be driven outwardly thereof by the fastener driving element.

In a fastening tool, for example, fasteners, are driven into a workpiece by a driver blade or driver member through a process known as a “drive” or “drive cycle”. Generally, a drive cycle involves the driver member striking a fastener head during a drive stroke to an extended position, and returning to a home or returned position during a return stroke.

In an existing fastening tool, the nosepiece includes a nose portion along which a driver member drives a fastener into a workpiece, and a door portion that covers the nose portion. During the drive cycle, the driver blade portion of the driver member reciprocates in a space between the nose portion and the door portion which keep the driver blade in alignment with the drive track.

During a drive cycle, however, it is possible that the tip of the driver blade can divert from the desired alignment and/or become disconnected from the door and nose when the driver member is in the home position.

Accordingly, there is a need in the art for a fastening tool that guides the tip of the driver blade so that the tip does not become disconnected from the door and nose when the driver member is in the home position.

### SUMMARY OF THE INVENTION

In an embodiment of the present invention, a fastening tool has a stationary member that can guide the tip of a driver blade along a drive track and can prevent the driver blade from becoming dislodged from the drive track when driver member is in the home position. The driver blade guide can both engage the tip of the driver blade and define a pivot axis about which a nose door can be opened to release a jammed fastener. When the door is in the open and closed positions, the driver blade can remain engaged with the driver blade guide.

In an embodiment, the fastening tool includes a housing having a drive channel; a nosepiece assembly connected to a forward end of the housing and having a nose portion that extends in a longitudinal direction and a door pivotably connected to the nose portion; a driver member provided in the housing and configured for movement within the drive channel from an extended position to drive a lead fastener through the nosepiece assembly and into a workpiece during a drive stroke to a returned position and home position during a return stroke. The driver member has a driver body and a connected a driver blade configured to contact a head portion of the lead fastener. A driver blade guide is mounted to the nose portion and configured to engage the driver blade when the driver member is in the home position.

The driver blade can be connected to the driver body at a proximal end and can have a tip portion at a distal end. The driver blade guide can be a stationary member disposed on the nose portion of the nosepiece assembly and configured to engage the tip portion of the driver blade when the driver member is in the home position.

The nose portion of the nosepiece assembly includes a pair of flanges projecting orthogonally with respect to the longitudinal direction on opposite lateral sides of the nose portion. The driver blade guide is nested between the flanges on the nose portion.

The driver blade guide includes an engagement surface that engages the tip of the driver blade. The engagement surface includes projections that extend into grooves on a nose door side of the driver blade.

The nose door is pivotably disposed on the nose portion to have an open position and a closed position.

The driver blade guide has a bifurcated body that includes a pair of shoulders that pivotably support the nose door on the nose portion. The driver blade guide also includes axially aligned apertures through the pair of shoulders for mounting a pivot pin of the nose door. The shoulder apertures are coaxial with the flange apertures.

The nose door is pivotable about a door pin that is disposed axially through the driver blade guide shoulder apertures and flange apertures.

In an embodiment, in both the open position and the closed position, the blade guide remains engaged with the tip of the driver blade.

In an embodiment, the fastening tool includes a housing having a drive channel; a nosepiece assembly connected to a forward end of the housing and having a nose portion that extends in a longitudinal direction; a driver member provided in the housing and configured for movement within the drive channel from an extended position to drive the lead fastener through the nosepiece assembly and into a workpiece. The driver member has a driver blade with a driver blade tip configured to contact a head portion of the lead fastener. A driver blade guide is mounted to the nose portion and configured to engage the driver blade tip when the driver member is in the home position.

In a second embodiment of the present invention, keeping the driver blade engaged with the driver blade guide can include pivotably mounting the door to the housing through a slot arranged perpendicular or orthogonal to the drive axis. The slot can allow the door to both pivot and slide toward and away from the drive track. The slot allows the door to slide upward or perpendicularly or orthogonally away from the drive axis before pivoting open and allows the rearmost portion of the door to engage the tip of the driver blade when the door is pivoted to an open position.

In a third embodiment of the present invention, keeping the driver blade engaged with the driver blade guide can include pivotably mounting the door to the housing through a slot arranged parallel to the drive axis. The slot can allow the door to both pivot and slide toward and away from the housing. The slot allows the door to slide forward or along the drive axis before pivoting open and allows the rearmost portion of the door to engage the tip of the driver blade when the door is pivoted to an open position.

In a fourth embodiment for keeping the driver blade engaged with the driver blade guide, a door having a separate hinge portion that can be pivotably connected to the housing. The hinge allows the rearmost portion of the door to engage the tip of the driver blade when pivoted open.

In an embodiment, the fastening tool may be a nailer or a stapler.

Additional features and benefits of the present invention are described, and will be apparent from, the accompanying drawings and the detailed description below.

### BRIEF DESCRIPTION OF THE DRAWINGS

The numerous advantages of the present invention may be better understood by those skilled in the art by reference to the accompanying Figures. In the drawings, like reference numerals designate corresponding parts throughout the several views.

FIG. 1 illustrates a fastening tool according to an embodiment of the present invention;

FIG. 2 illustrates the fastening tool of FIG. 4 with the housing removed;

FIG. 3 illustrates a partial view of the driver blade guide in the tool of FIG. 1;

FIGS. 4A and 4B illustrate the driver member in the tool of FIG. 1;

FIGS. 5A and 5B are side perspective views of the nose door and driver guide blade in the tool of FIG. 1 having the nose door in the opened and closed positions, respectively;

FIG. 6 illustrates the driver blade tip engagement with the driver blade guide in the tool of FIG. 1;

FIG. 7 illustrates the driver blade guide in the tool of FIG. 1;

FIG. 8 illustrates the exploded view of the driver blade guide in the tool of FIG. 1;

FIG. 9 illustrates the assembled rear perspective view of the driver blade guide in the tool of FIG. 1;

FIG. 10 illustrates the exploded front perspective view of the driver blade guide in the tool of FIG. 1;

FIG. 11 illustrates the assembled front perspective view of the driver blade guide in the tool of FIG. 1;

FIGS. 12A and 12B illustrate side views of the driver blade guide in the opened and closed positions, respectively, in accordance with a second embodiment of the present invention;

FIGS. 13A and 13B illustrate side views of the driver blade guide in the opened and closed positions, respectively, in accordance with a third embodiment of the present invention;

FIGS. 14A and 14B illustrate side views of the driver blade guide in the opened and closed positions, respectively, in accordance with a fourth embodiment of the present invention;

Corresponding reference names and/or numerals indicate corresponding parts throughout the several views of the drawings.

### DETAILED DESCRIPTION OF THE INVENTION

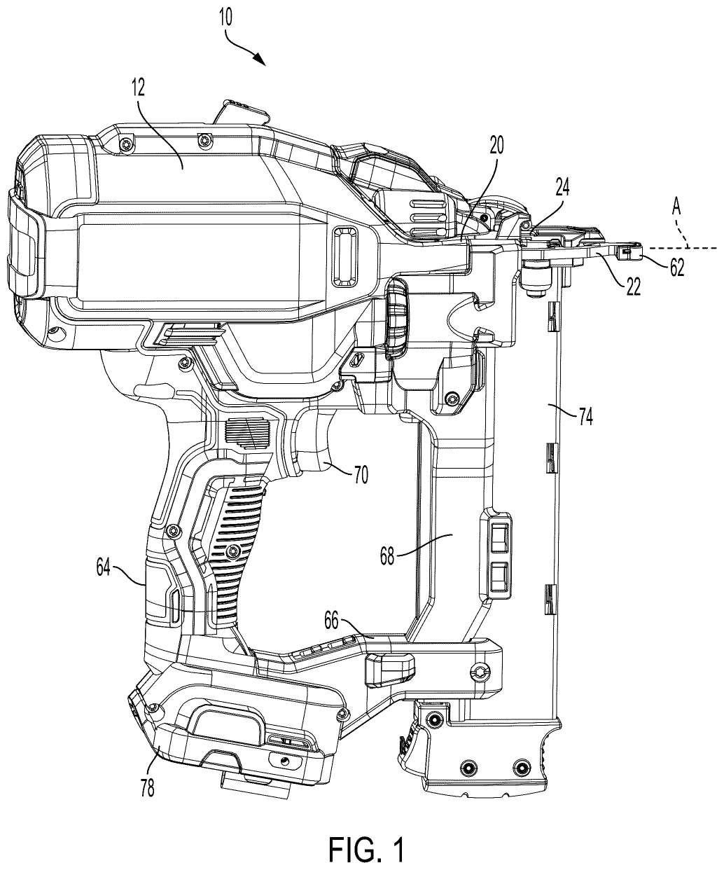

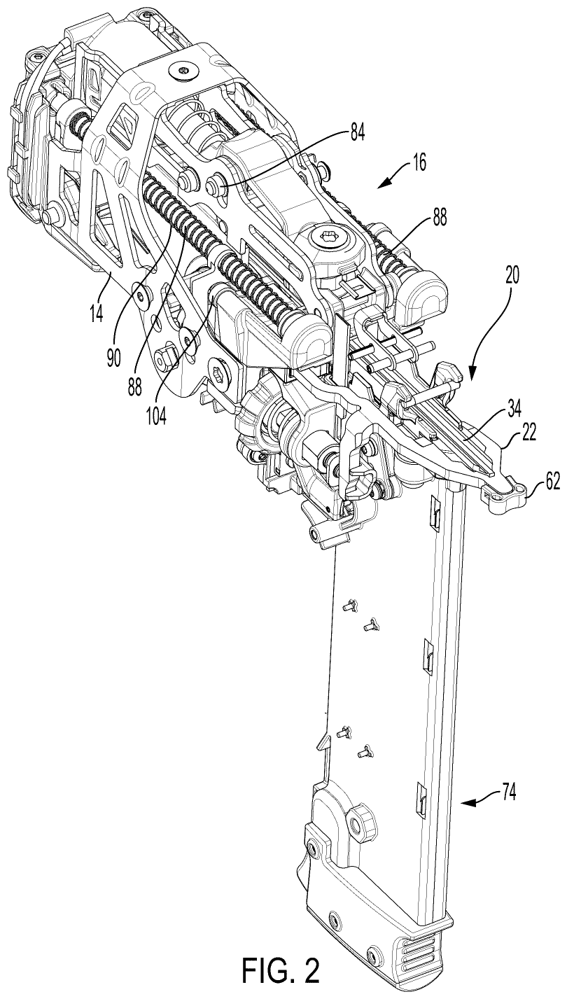

With reference to FIGS. 1 and 2 of the drawings, a fastening tool 10 constructed in accordance with the teachings of the present invention is illustrated. According to several aspects, the fastening tool 10 is a cordless nailer for driving fasteners such as nails into a workpiece. The fastening tool 10 may include a housing 12, a backbone or frame 14 supported within the housing, a drive motor assembly 16, a controller or control module 18, a nosepiece assembly 20 extending forward of and fixed to the housing 12. The nosepiece assembly 20 includes a nose portion 22 that can be placed against the workpiece for driving a fastener. The nosepiece assembly 20 defines a fastener drive track 24 through which the fasteners F, such as nails or staples, are driven during a drive stroke. The fastener drive track 24 is connected to a drive channel 26. The drive channel 26 is defined within the housing interior and a within which, a driver member 30 is reciprocally mounted on a return mechanism 88 for movement along a fastening tool drive axis A, to drive the fastener. The driver member 30 is further supported on a driver blade guide 110 fixedly mounted on the nose portion 22. A magazine assembly 74 is carried by the housing 12 and is configured to hold a plurality of fasteners and configured to present a lead fastener of the plurality of fasteners into a drive channel 26.

With additional reference to FIG. 2, the frame 14 may be a structural element upon which the drive motor assembly 16, control module 18, the nosepiece assembly 20 and/or the magazine assembly 74 may be fully or partially mounted.

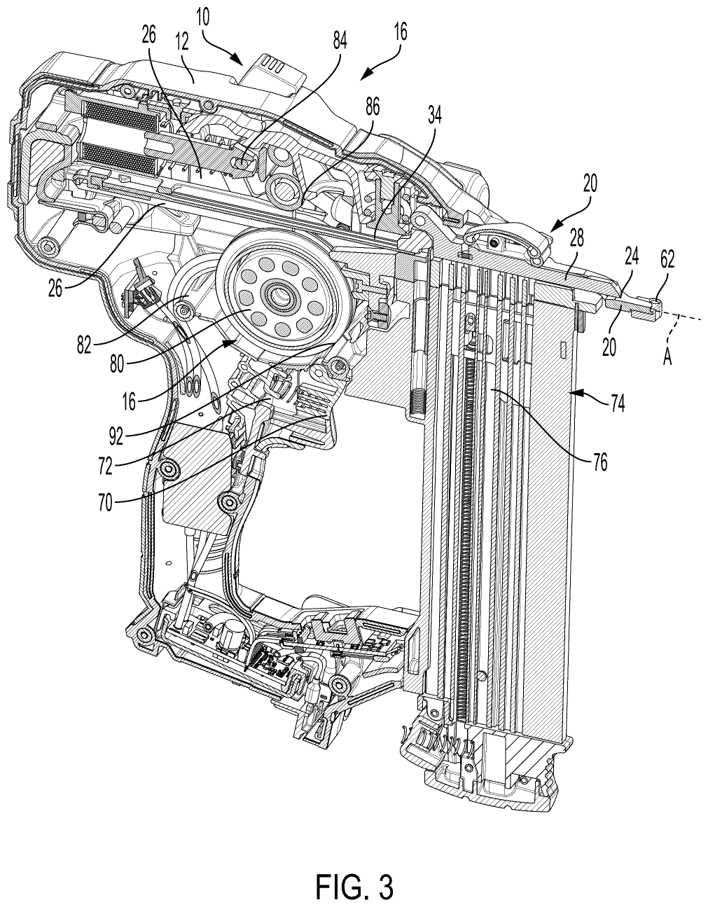

As shown in FIGS. 2 and 3, the drive motor assembly 16 may include a motor 80 and a flywheel 82 that are operable for propelling the driver member 30 in a first direction along the drive axis A. In the embodiments herein, the first direction is a forward direction toward the nose portion 22 of the tool 10. The motor 80 is operably coupled to the flywheel 82 to rotate the flywheel 82. For example, the motor 80 can be an outer rotor brushless motor where the flywheel 82 is an integral part of the outer rotor. Alternatively, motor 80 can be drivingly coupled to flywheel 82 via a transmission (not shown).

Also, as shown in FIG. 2, mounted to the frame 14 are a carrier 54 that supports a follower assembly 84, including a pinch wheel or follower 86. The follower assembly 84 has a locked over-center position in which the driver member 30 can be pinched between the follower 86 and the flywheel 82, subjecting the driver member to a pinch force when the driver member is in the stall position.

The drive motor assembly 16 also includes a return mechanism 88 that returns the driver member 30 to the returned position. The return mechanism 88 can include return springs 90 that compress to absorb the return force applied by the driver member 30. The return springs 90 are compressed during the drive stroke and operate to bias the driver member 30 to the returned position during the return stroke.

The drive motor assembly 16 may be actuated by the control module 18 to cause the driver member 30 to translate and impact a fastener in the nosepiece assembly 20 so that the fastener may be driven into the workpiece. The control module 18 is configured to control a supply of power from the battery to the motor 80 to initiate and activate the drive cycle upon receipt of the trigger signal. In an embodiment, the control module 18 moves the follower 86 that is associated with the follower assembly 84, which squeezes the driver member 30 into engagement with the flywheel 82 so that energy may be transferred from the flywheel to the driver member to cause the driver member to translate. In this way, the control module 18 is arranged to initiate frictional engagement between the outer rim 92 of the flywheel 82 and the driver profile 36 to transmit energy from the flywheel 82 to the driver member 30 to accelerate the driver along the drive axis A for the drive stroke. The nosepiece assembly 20 guides the fastener as it is being driven into the workpiece.

In addition to the driver member 30 being movable along a drive axis A from a returned position to an extended position to drive a fastener, the driver member 30 is also movable in a radial direction relative to the flywheel 82 between an engaged or firing position (FIG. 2) and a home position (FIG. 3). In the firing position, the driver member 30 is drivingly engaged against the flywheel 82. In the home position, the driver member 30 is radially further away from the flywheel 82 than in the firing position.

The drive track 24 receives a first fastener of a collated strip of fasteners and guides the fastener out of the nosepiece assembly 20 when the fastener to be driven into a workpiece is struck by the driver member 30.

In an embodiment, a no-mar tip 62 can be attached to the nose portion 22 of the nosepiece assembly 20 to prevent marring of the workpiece when the nose portion is placed against the workpiece for driving the fastener. Additionally, a nose door 28 is provided on the nose portion 22 to trap a portion the driver member 30 between it and the nose portion 22.

A handle portion 64 of the tool extends from the housing 12. The handle 64 is configured to be received by a user's hand, thereby making the fastening tool portable. Additional portability can be achieved by constructing the housing from a lightweight yet durable material, such as magnesium. The handle 64 includes a connecting portion 66 and a housing extension 68 that extends substantially parallel to the handle 64.

As shown in FIG. 3, a trigger assembly 70 is connected to the handle 64. The trigger assembly 70 serves as an actuation device or actuator for the fastening tool, and is constructed and arranged to actuate a switch assembly 72. The trigger switch can be part of the control module that includes sensors that sense the state of various components, such as the trigger, and generates signals in response thereto.

The trigger assembly 70 may be coupled to the housing 12 and is configured to receive an input from the user, typically by way of the user's finger, that may be employed in conjunction with the trigger switch assembly 72 to generate a trigger signal that may be employed in part to initiate the drive cycle of the fastening tool to drive the fastener into the workpiece.

The magazine assembly 74 is connected to the nose portion 22 of the nosepiece assembly 20 at one end and is connected to the connecting portion 66 of the housing 12 at an opposite end. The magazine assembly 74 is constructed and arranged to feed successive leading fasteners along a fastener channel 76 and into the drive track 24. In an embodiment, the supply of fasteners can be collated fasteners. The supply of fasteners is urged toward the drive track 24 by at least one magazine pusher or a plurality of magazine pushers that are slidably disposed in the magazine assembly 74. The magazine pusher travels along the magazine pusher path or the fastener channel 76. The fastener channel 76 has a width that accommodates the fasteners. The fastener channel 76 extends into the nose portion 22 of the nosepiece assembly 20. The magazine pusher is biased towards the drive track 24 by a spring or plurality of springs. The magazine pusher engages the last fastener in the supply of fasteners to thereby feed individual fasteners from the fastener channel 76 in the magazine assembly 74 to the fastener channel in the nose portion 22.

In an embodiment, the fastening tool 10 is battery powered. A battery mount 78 is provided for removably mounting a battery pack (not shown) to the fastening tool 10.

The driver member 30 is movable within the drive channel 26 relative to the frame 14 between a returned position and an extended position. The driver member 30 includes a driver body 32 at one end and a driver blade 34 for striking the head of a fastener during the drive stroke at an opposite end. The driver blade 34 is connected to the driver body 32 at a proximal end and has a free distal end.

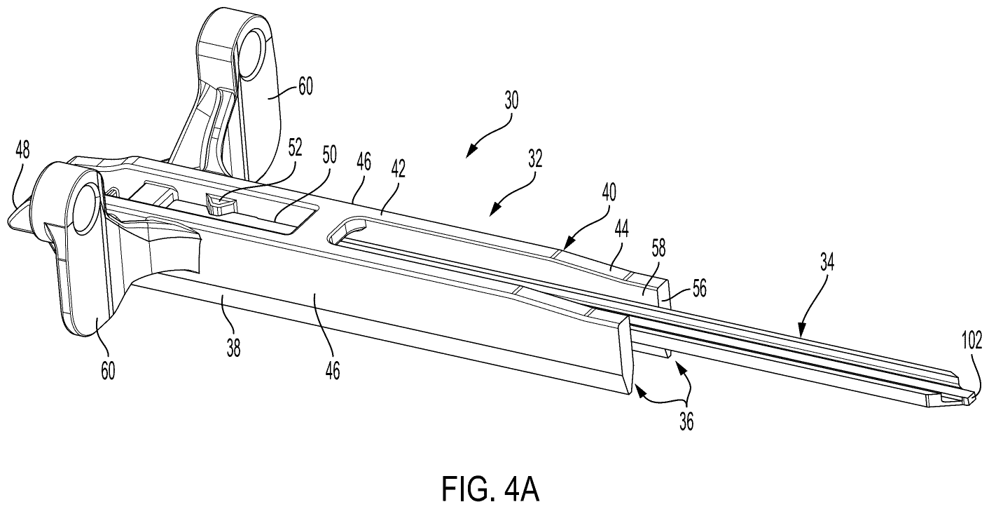

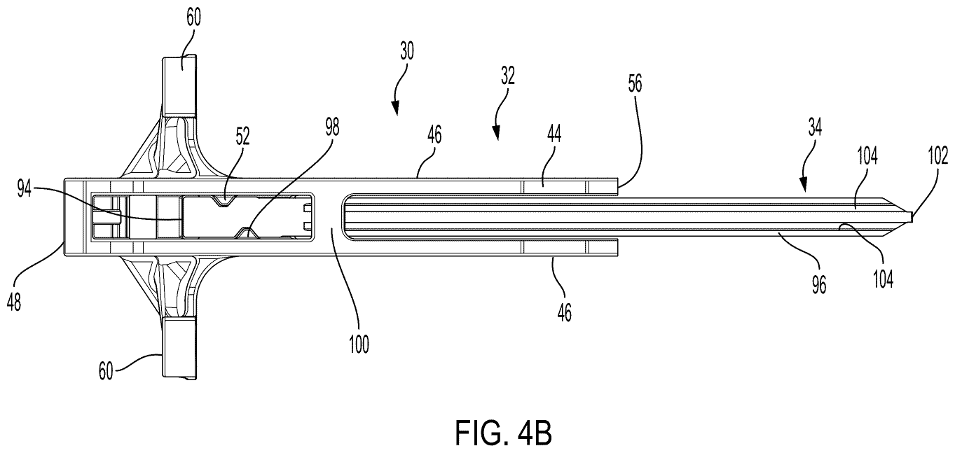

As shown in FIGS. 4A and 4B, the driver body 32 of the driver member 30 may include a driver profile 36, a cam profile 40, an abutment 48, a blade recess 50, and a blade aperture 100.

With additional reference to FIG. 4A, the driver profile 36 is disposed on the flywheel side of driver member 30 and is shaped to engage the exterior surface of the outer rim 92 of the flywheel 82, so that the flywheel can deliver kinetic energy to propel the driver member 30.

The driver profile 36 forms a lower contour of the driver body 32 and is configured in a manner that is complementary to the exterior surface of outer rim 92 of the flywheel 82. In the particular example provided, the driver profile 36 includes a pair of longitudinally extending V-shaped teeth 38 that cooperate to form at least one passage therebetween. The exterior surface of the outer rim 92 of the flywheel 82 has complementary V-shaped teeth and grooves 93 that mesh with the driver profile. As such, the driver profile 36 is configured for engaging grooves 93 on the flywheel 82. The outer rim 92 of the flywheel and the driver body, respectively, provide a space into which the V-shaped teeth, respectively, may extend as the exterior surface of the outer rim of the flywheel 82 and/or the driver profile 36 wear away to thereby ensure contact between the exterior surface and the driver profile along a substantial portion of the V-shaped teeth, rather than point contact.

To further control wear, a coating may be applied to the driver body 30 at one or more locations, such as over the driver profile 36 and the cam profile 40. The coating may be a type of carbide, such as titanium carbide, and may be applied via a plasma spray, for example. Alternatively, a ferric nitro carburizing heat treatment or coating can be used.

With further reference to FIGS. 4A and 4B, the cam profile 40 of the driver body 32 is located on the follower side of the driver member 30 opposite the driver profile 36. The cam profile 40 includes a raised cam profile 42 and a transition cam profile 44 against which the follower 86 engages. As the follower 86 rides up the transition cam profile 44, the pinching force acting on the driver member 30 between the follower 86 and the flywheel 82 increases. The raised and transition cam profiles can be formed on a pair of rails 46.

The driver body 32 also includes an end surface or abutment 48 on a side opposite the side from which the driver blade 34 extends. The abutment 48 may be configured to slope away from the driver profile 36.

The blade recess 50 may be a longitudinally extending cavity that may be disposed between the rails 46 of the cam profile 40. The blade recess may define a blade recess engagement structure for engaging the driver blade. The blade recess engagement structure includes teeth 52 which may be located on opposite lateral sides of the blade recess. In the example provided, the blade recess engagement structure defines a serpentine-shaped channel, having a flat bottom. The teeth 52 engage a corresponding surface at the rear or proximal portion of the driver blade 34.

The driver body 32 is open at the forward end 56 and there is a space between the inner sides 58 of the rails 46 and the driver blade 34. The opening extends longitudinally through a portion of the driver body and defines the blade recess 50 at an opposite closed end. The open forward end 56 is defined by the rails 46. The driver body 32 can be closed at the abutment 48 at the rear end.

The driver body 32 has a pair of projections or ears 60 at the rear end adjacent to the abutment 48 that extend laterally on each side. The ears 60 are used to stop forward movement of the driver member 30 after a fastener has been installed in a workpiece. The ears 60 define a contact surface that may be planar in shape, and which may be generally orthogonal to the longitudinal axis of the driver member 30. In an embodiment, the pair of ears 60 are generally parallel to one another and disposed on opposite lateral sides of the driver profile 36.

The distal end of the driver blade 34 can contact against the head of a fastener and drive the fastener as the driver member 30 moves to its axially extended position. In the axially extended position, the ears 60 of the driver member 30 can contact against housing bumper members 104.

The driver blade 34 itself may include a retaining portion 94 and a blade body 96. The retaining portion 94 secures the driver blade 34 to the driver body 32 and may be configured to inhibit movement of the driver blade relative to the driver body in a direction that is generally transverse to the longitudinal axis of the driver member.

The retaining portion 94 may include a corresponding blade engagement structure that is configured to engage the blade recess engagement structure or teeth 52 in the driver body. In the particular example provided, the corresponding blade engagement structure includes a plurality of blade teeth 98 that are received into the serpentine-shaped channel of the blade recess 50 and into engagement with the teeth 52 that form the blade recess engagement structure. Engagement of the blade recess engagement structure or teeth 52 and the blade engagement teeth 98 substantially inhibits motion between the driver blade 34 and the driver body 32.

Returning to FIGS. 4A and 4B, the blade portion 34 extends from the retaining portion 94 and through the blade aperture 100 in the driver body 32. The blade body 96 of the driver blade 34 may include a tip portion 102 at a distal end. The tip potion 102 is planar in a conventional manner (e.g., on the side against which the fasteners in the magazine assembly 74 are fed) and tapered on its laterally opposite sides. The blade body 96 also has a plurality of grooves 106 on the nose door side which is opposite to the side against which the fasteners in the magazine assembly 74 are fed.

The driver body 32 may be unitarily formed in an appropriate process, such as investment casting, from a suitable material, such as a ferromagnetic material. In an embodiment, the driver body 32 and the driver blade 34 can be formed of a metal including, but not limited to steel and titanium.

In operation, fasteners are stored in the magazine assembly 74, which sequentially feeds the fasteners into the nosepiece assembly 20 and positions fasteners in line with the driver member 30. The drive motor assembly 16 as actuated by the control module 18 causes the driver member 30 to translate and impact a fastener in the nosepiece assembly so that the fastener may be driven into a workpiece. Actuation of the motor 80 may be by use of electrical energy from the battery pack (not shown) to operate the motor 80 of the drive motor assembly 16, the control module 18 and the trigger assembly 70. The motor 80 is employed to drive the flywheel 82.

With driver body 32 being open at the forward end 56 on the fastener driving direction side of the tool, during the drive stroke, the driver body is able to overlap the fastener channel. During the drive stroke, and while the follower assembly squeezes the driver member into engagement with the flywheel, the driver body 32 straddles the fastener channel 76 through the nose portion 22 and the magazine 74, and the forward surface 56 of the driver member 30 overlaps the fastener channel in a direction parallel to the drive axis A.

Also, with the forward end of the driver body 32 being open in order to straddle the fastener channel 76, the driver blade guide 110 provides additional support to the driver blade 34. As shown in FIG. 3, the driver blade guide 110 is disposed on the nose portion 22 of the nosepiece assembly 20. In an embodiment, the driver blade guide 110 is disposed at the proximal end of the nose portion 22 so that it can engage the driver blade tip 102 when the driver member 30 is in the home position. The blade guide 110 is disposed along the drive track 24 and is shorter in length than the nose portion 22.

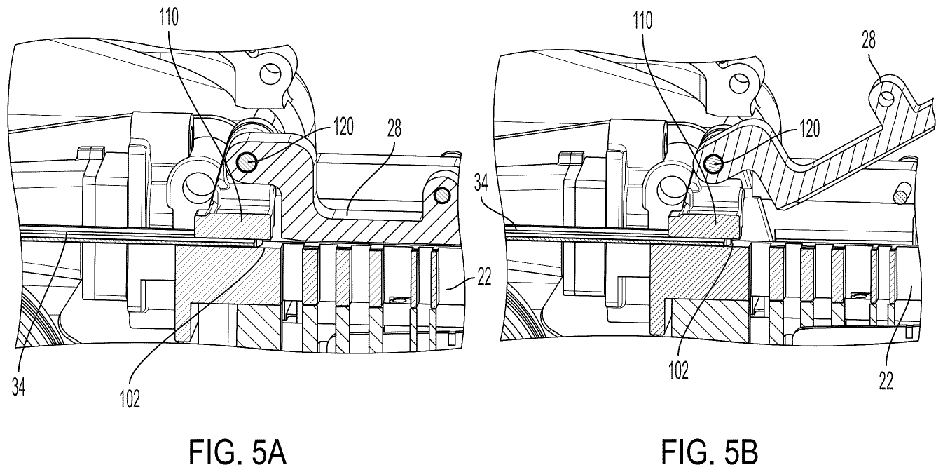

In an embodiment of the present invention, as shown in FIG. 3, 5A, 5B and 6, the driver blade guide 110 can engage the driver blade 34 of the driver member 30 along the drive track 24 and can prevent the driver blade from becoming dislodged from the drive track. In particular, the driver blade guide 110 retains the driver blade tip 102 against the nose portion 22 of the fastening tool 10 when the driver member 30 is in the home position. The driver blade guide 110 can both engage the tip 102 of the driver blade 34 and define a pivot axis about which the nose door 28 can be opened to release a jammed fastener. When the nose door 28 is in the open (FIG. 5A) and closed (FIG. 5B) positions, the driver blade 34 can remain engaged with the driver blade guide 110.

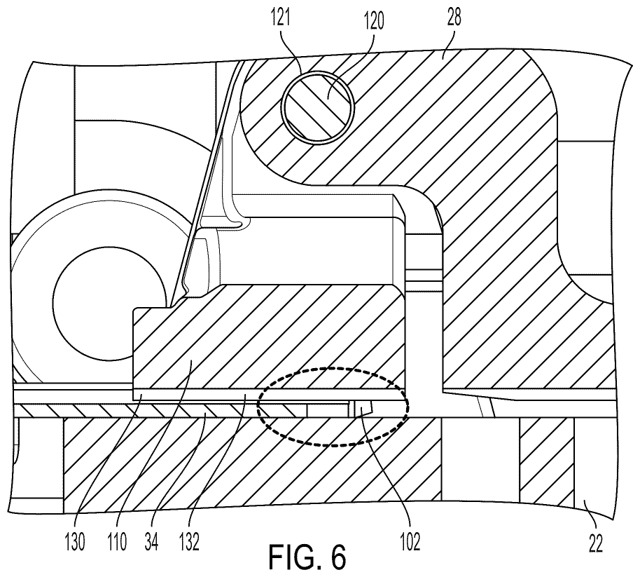

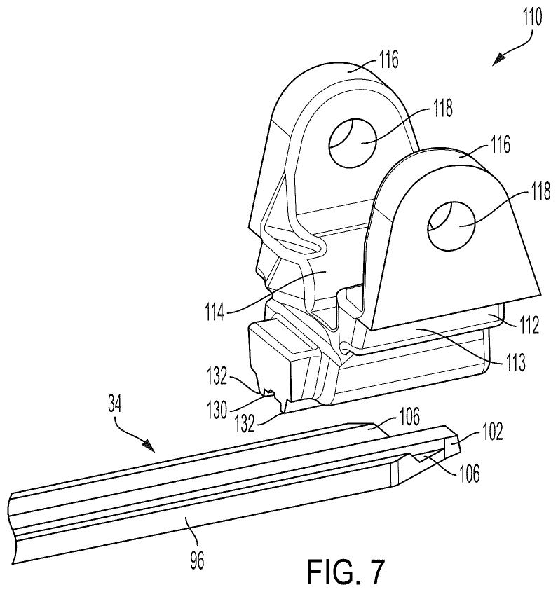

As shown in FIGS. 6 and 7, the driver blade guide 110 includes an engagement surface 130 that engages the tip of the driver blade. The engagement surface can include projecting portions 132 that extend into grooves 106 in the driver blade body 96. The grooves 106 of the driver blade body 96 face away from the fastener channel 76. As further shown in FIG. 6, which is an enlarged view of the engagement between the driver blade tip 102 and driver blade guide 110, the projecting portions 132 of the driver blade guide are disposed in the grooves 106 in the driver blade guide side of the driver blade body 96.

In an embodiment, shown in FIG. 7, the driver blade guide 110 has a bifurcated body that defines a pair of ledges 112 and a cavity 114 therebetween. The ledges 112 extend outwardly or in opposite directions and away from the cavity 114. The ledges have an outer side surface 113. The driver blade guide 110 also has shoulders 114 that project outwardly from the ledges 112 in a direction opposite to the fastener channel 76. In an embodiment, the shoulders 116 project orthogonally from the driver blade guide 110 ledges. The shoulders 116 have apertures 118 therethrough that serve as part of the support for the nose door 28. The apertures 118 support a nose door pin 120 that passes through the carrier 54 in the drive motor assembly 16, the nose door 28 and the shoulders 116, to allow the nose door to be pivotable. In an embodiment, the nose door pin 120 can be made from a metal, such as steel.

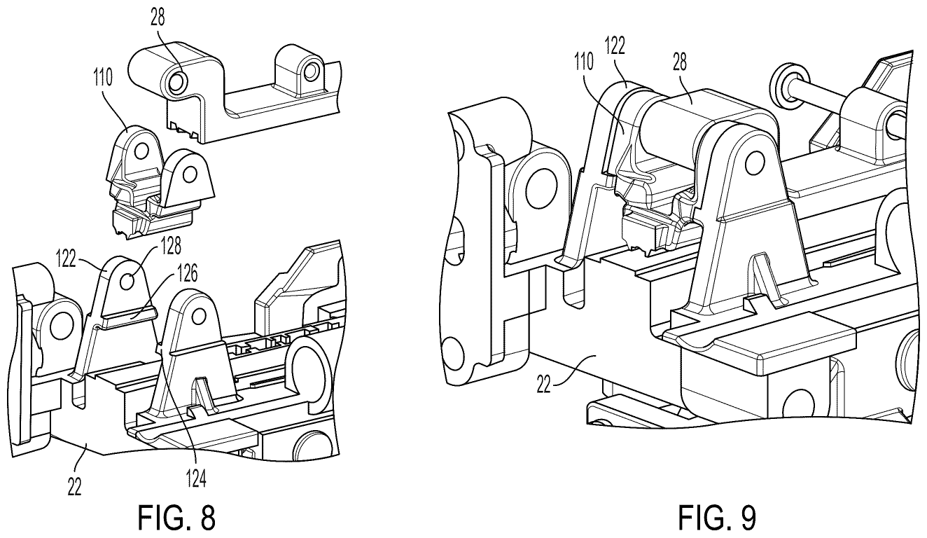

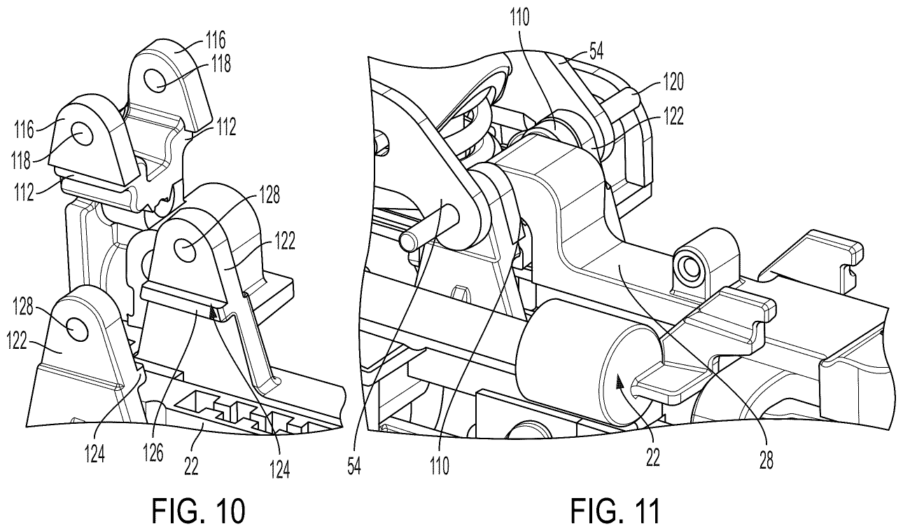

As shown in FIGS. 8A, 8B, 9 and 10, the driver blade guide 110 acts as an extension to the back of the nose door 28. The driver blade guide 110 remains stationary with respect to the nose portion 22 of the tool 10 and covers an area of the drive track 24 between the door and the nose portion 22. As such, the driver blade guide 110 can also engage a rear portion of the driver blade 34.

The driver blade guide is mounted on the nose portion 22 of the nosepiece assembly 20. The nose portion 22 of the nosepiece assembly 20 includes a pair of flanges 122 that project outward from a surface thereof. In an embodiment, the pair of flanges 122 project orthogonally with respect to the longitudinal body of the nose portion 22. The pair of flanges 122 are disposed on opposite lateral sides of the drive track 24. In an embodiment, the flanges 122 are integrally formed on the nose portion 22. Each flange has a ledge 124 that projects inwardly toward the other flange. In an embodiment, the flange ledges 124 on the opposing flanges are mirror opposite.

The driver blade guide 110 is disposed on the flange ledges 124. The flange ledges 124 support the shoulders 116 of the driver blade guide 110. As shown, each shoulder 116 is supported on a ledge. The outer side surfaces 113 of the ledges 112 on the driver blade guide 110 abut the inner side surfaces 126 of the flange ledges. Ledges 112, 124 on both the driver blade guide 110 and the flanges prevents the driver blade guide 110 from rotating with respect to the nose portion 22 The ledges 112, 124 also suspend the driver blade guide 110 over the nose portion 22. As illustrated, the driver blade guide 110 is nested in the nose portion flanges 124. Each flange also has an aperture 128 therethrough that is axially aligned with the apertures 118 in the shoulders 116 of the driver blade guide 110. The aligned apertures in the driver blade guide 110 and the flanges receive the door pin 120 upon which the nose door 28 pivots.

In further embodiments of the present invention, the driver blade guide feature can be the rear edge or rearmost portion of the nose door in which the driver blade 34 is always engaged with the rear edge of the door when the door is in at least one of a closed position and an open position.

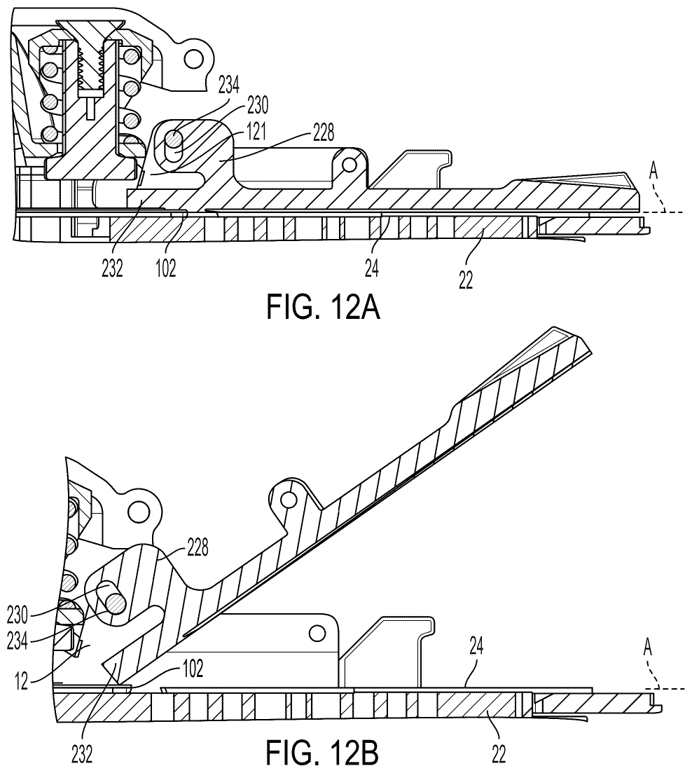

For example, in a second embodiment of the present invention shown in FIGS. 12A and 12B, keeping the driver blade 34 engaged with a driver blade guide feature can include pivotably mounting the nose door 228 to the housing 12 through a slot 230 arranged orthogonal to the drive axis A. The slot 230 can allow the nose door 228 to both pivot and slide toward and away from the drive track 24. The slot 230 allows the nose door 228 to slide upward or orthogonally away from the drive axis A before pivoting open and allows the rearmost portion 232 of the nose door to engage the tip 102 of the driver blade 34 when the nose door 228 is pivoted to an open position.

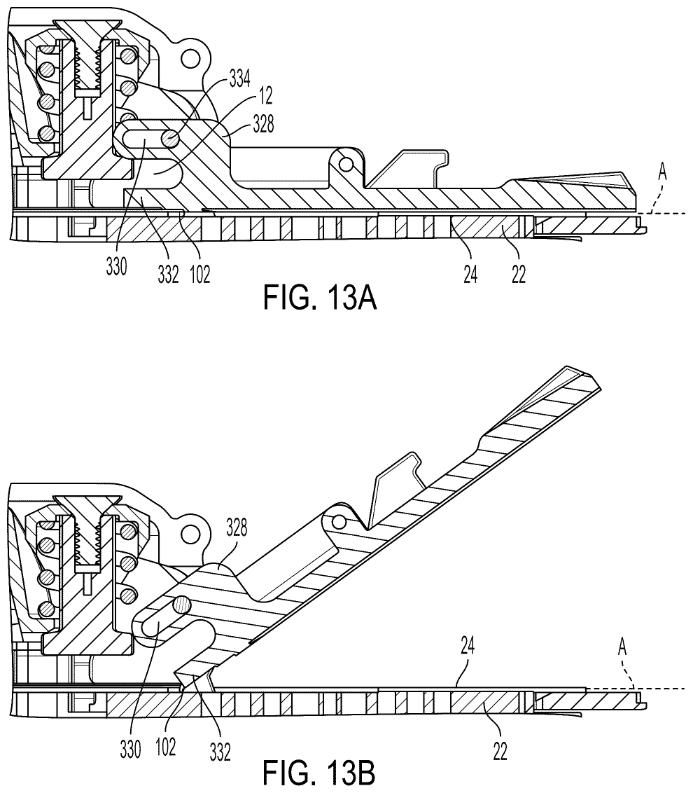

Also, for example, in a third embodiment of the present invention shown in FIGS. 13A and 13B, keeping the driver blade 34 engaged with a driver blade guide feature can include pivotably mounting the nose door 328 to the housing 12 through a slot 330 arranged parallel to the drive axis A. The slot 330 can allow the nose door 328 to both pivot and slide toward and away from the housing 12. The slot 330 allows the nose door 328 to slide forward or along the drive axis A before pivoting open and allows the rearmost portion 332 of the nose door 328 to engage the tip 102 of the driver blade 34 when the nose door is pivoted to an open position.

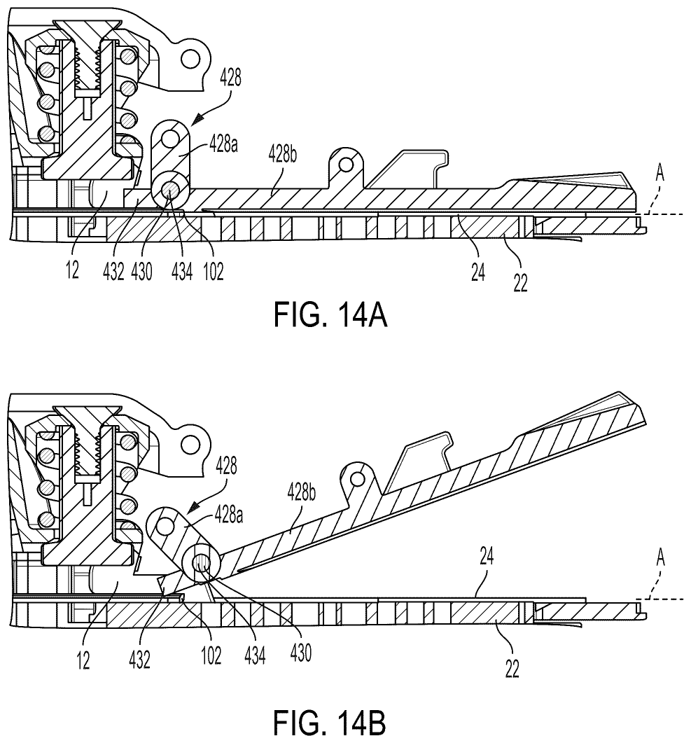

In a fourth embodiment of the present invention shown in FIGS. 14A and 14B, for keeping the driver blade 34 engaged with a driver blade guide feature, a nose door 428 being an articulated door with a linkage 428a, 428b with separate hinge portion 430 that can be pivotably connected to the housing 12 through a hinge pin 434. The hinge 430 allows the rearmost portion 432 of the nose door 428 to engage the tip of the driver blade 34 when pivoted open.

While the fastening tool is illustrated as being electrically powered by a suitable power source, such as a battery pack, those skilled in the art will appreciate that the invention, in its broader aspects, may be constructed somewhat differently and that aspects of the present invention may have applicability to any type of portable tool. Further, the fastening tool in the embodiment described herein can be powered by a number of other power sources. For example, power sources for the fastening tool can be manual, pneumatic, electric, combustion, solar or use other (or multiple) sources of energy.

Furthermore, while aspects of the present invention are described herein and illustrated in the accompanying drawings in the context of a nailer, those of ordinary skill in the art will appreciate that the invention, in its broadest aspects, has further applicability. For example, the drive motor assembly may also be employed in various other mechanisms that use reciprocating motion, including rotary hammers, hole forming tools, such as punches, and riveting tools, such as those that install deformation rivets.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made, and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

We claim:

1. A tool comprising:
a housing having a drive channel;
a nosepiece assembly connected to a forward end of the housing and having a nose portion that extends in a longitudinal direction and a door pivotably connected to the nose portion;
a driver member provided in the housing and configured for movement within the drive channel from an extended position to drive the lead fastener through the nosepiece assembly and into a workpiece during a drive stroke to a returned position and home position during a return stroke, the driver member having a driver body and a connected a driver blade configured to contact a head portion of the lead fastener; and
a driver blade guide mounted to the nose portion and configured to engage the driver blade when the driver member is in the home position.

2. The tool according to claim 1, wherein the driver blade is connected to the driver body at a proximal end and comprises a tip portion at a distal end, and
wherein the driver blade guide is configured to engage the tip portion of the driver blade when the driver member is in the home position.

3. The tool according to claim 1, wherein the driver blade guide is stationary.

4. The tool according to claim 1, wherein the driver blade guide is disposed on the nose portion of the nosepiece assembly.

5. The tool according to claim 1, wherein the nose portion comprises a pair of flanges projecting orthogonally with respect to the longitudinal direction on opposite lateral sides of the nose portion.

6. The tool according to claim 5, wherein the driver blade guide is nested between the flanges on the nose portion.

7. The tool according to claim 1, wherein the driver blade guide comprises an engagement surface that engages the tip of the driver blade.

8. The tool according to claim 7, wherein the engagement surface comprises projections that extend into grooves on a nose door side of the driver blade.

9. The tool according to claim 1, further comprising a nose door pivotably disposed on the nose portion to have an open position and a closed position.

10. The tool according to claim 9, wherein the driver blade guide has a bifurcated body.

11. The tool according to claim 10, wherein the bifurcated body comprises a pair of shoulders that pivotably support the nose door on the nose portion.

12. The tool according to claim 11, wherein the driver blade guide comprises axially aligned shoulder apertures through the pair of shoulders for mounting a pivot pin of the nose door.

13. The tool according to claim 12, further comprising flanges projecting from the nose, the flanges having coaxial flange apertures; and
wherein the axially aligned apertures through the pair of shoulders are coaxial with the flange apertures.

14. The tool according to claim 13, wherein the nose door is pivotable about a door pin that is disposed axially through the driver blade guide shoulder apertures and flange apertures.

15. The tool according to claim 9, wherein in both the open position and the closed position, the blade guide remains engaged with the tip of the driver blade.

16. A tool comprising:
a housing having a drive channel;
a nosepiece assembly connected to a forward end of the housing and having a nose portion that extends in a longitudinal direction;
a driver member provided in the housing and configured for movement within the drive channel from an extended position to drive the lead fastener through the nosepiece assembly and into a workpiece, the driver member having a driver blade with a driver blade tip configured to contact a head portion of the lead fastener; and
a driver blade guide mounted to the nose portion and configured to engage the driver blade tip when the driver member is in the home position.
